(19) United States
(12) Patent Application Publication
(10) Pub. No.: US 2023/0321911 A1
(43) Pub. Date: Oct. 12, 2023

(54) THREE-DIMENSIONAL PRINTING DEVICE

(71) Applicant: Young Optics Inc., Hsinchu Science Park (TW)

(72) Inventors: You-Ren WANG, Hsinchu Science Park (TW); TSUNG-YU LIU, Hsinchu Science Park (TW)

(21) Appl. No.: 18/130,624

(22) Filed: Apr. 4, 2023

(30) Foreign Application Priority Data
Apr. 8, 2022 (TW) 111113354

(51) Int. Cl. B29C 64/277; B29C 64/223; B29C 64/245; B29C 64/255; B29C 64/106

(52) U.S. Cl. CPC B29C 64/277; B29C 64/223; B29C 64/245; B29C 64/255; B29C 64/106; B33Y 30/00

(57) ABSTRACT

A three-dimensional printing device including a rigid optically transparent plate, a release film, an adhesive layer, a light source, and a reflection assembly is provided. The rigid optically transparent plate has a first surface and a second surface opposite the first surface, the release film is disposed on a side of the rigid optically transparent plate adjacent to the first surface, and the adhesive layer is arranged between the rigid optically transparent plate and the release film. The light source is disposed on a side of the rigid optically transparent plate adjacent to the second surface, and the reflection assembly includes at least one mirror and is arranged at a position capable of forming a light path from the light source to the rigid optically transparent plate.

### BACKGROUND OF THE INVENTION

### a. Field of the Invention

The invention relates to a three-dimensional printing device.

### b. Description of the Related Art

FIG. 1 is a schematic diagram of a conventional three-dimensional printing device. As shown in FIG. 1, a photopolymer 14 is stored in a material tank 12 of a three-dimensional printing device 10. After the photopolymer 14 is cured through UV radiation, a curing platform 16 moves upwards to perform peeling actions. Specifically, when an adhesive force applied between the curing platform 16 and a hardened section 24 is greater than an adhesive force applied between a release film 18 of an optically transparent plate and the hardened section 24, the hardened section 24 is allowed to be separated from the release film 18. Then, the curing platform 16 moves downwards and the above-mentioned peeling process is repeated to form a 3D object comprised of multi-layer hardened sections 24. However, mechanical release from a flexible release film 18 may cause it to be pulled up to some extent and thus require that the curing platform 16 be advanced a greater distance to complete a release action, therefore lengthening the printing time. Besides, the release film 18 that is repeatedly pulled and released during the peeling process may result in a shortened service life. Therefore, it is desirable to provide a 3D printing device that may achieve good printing efficiency and avoid the above-mentioned problems.

### BRIEF SUMMARY OF THE INVENTION

According to an embodiment of the invention, a three-dimensional printing device includes a rigid optically transparent plate, a release film, an adhesive layer, a light source and a reflection assembly. The rigid optically transparent plate has a first surface and a second surface opposite the first surface, the release film is disposed on one side of the rigid optically transparent plate adjacent to the first surface, and the adhesive layer is arranged between the rigid optically transparent plate and the release film. The light source is disposed on one side of the rigid optically transparent plate adjacent to the second surface, and the reflection assembly includes at least one mirror and is arranged at a position capable of forming a light path from the light source to the rigid optically transparent plate.

According to another embodiment of the invention, a three-dimensional printing device includes a light source capable of emitting a light beam, a micro-mirror assembly arranged in a downstream light path of the light source, a projection lens arranged in a downstream light path of the micro-mirror assembly, a material tank provided with a space for accommodating a photo-curable material, a rigid optically transparent plate, and a release film disposed in a downstream light path of the rigid optically transparent plate. The rigid optically transparent plate is disposed at a bottom of the material tank and in a downstream light path of the projection lens, and the rigid optically transparent plate has a first surface and a second surface opposite the first surface. The release film is configured to be fixed on the rigid optically transparent plate during a printing process of the three-dimensional printing device.

The three-dimensional printing device of the invention has at least one of the following advantages. According to various embodiments of the invention, because the release film is fixed on a rigid member during the printing process, the release layer would not be pulled repeatedly to avoid deformation, so the service life of the release film can be increased, and an advanced distance of the curing platform and printing time can be shortened to improve the printing efficiency of a three-dimensional printing device. Further, with the designs of the above embodiments, the reflection assembly and the light source of the imaging unit are disposed far away from the adhesive layer or the coating layer, and the rigid member to which the adhesive layer or the coating layer is attached is an optically transparent plate without any electronic component to avoid heat generation. This may prevent heat from transmitting to the adhesive layer, the coating layer or the newly formed hardened section and hence reduce the possibility of softening, deteriorating or damaging the adhesive layer, the coating layer or the hardened section.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of a conventional three-dimensional printing device.

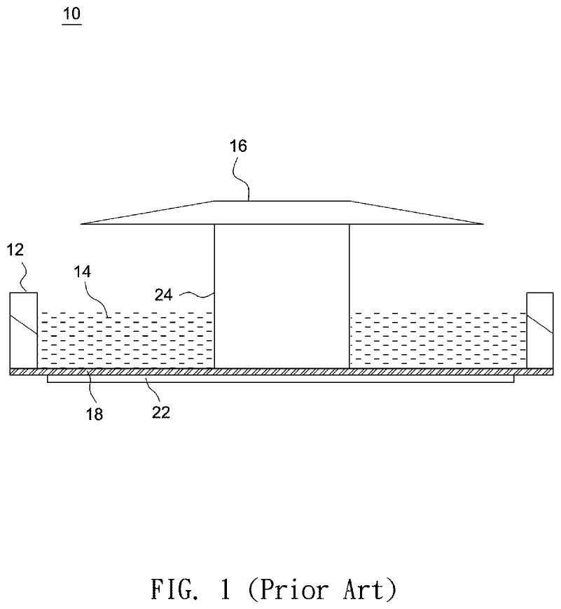

FIG. 2 is a schematic structural diagram of a three-dimensional printing device according to an embodiment of the invention.

FIG. 3 is a schematic structural diagram of a three-dimensional printing device according to another embodiment of the invention.

FIG. 4 is a schematic structural diagram of a three-dimensional printing device according to another embodiment of the invention.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc., as used herein, are used as labels for nouns that they precede, and do not imply any type of ordering (e.g., spatial, temporal, logical, etc.).

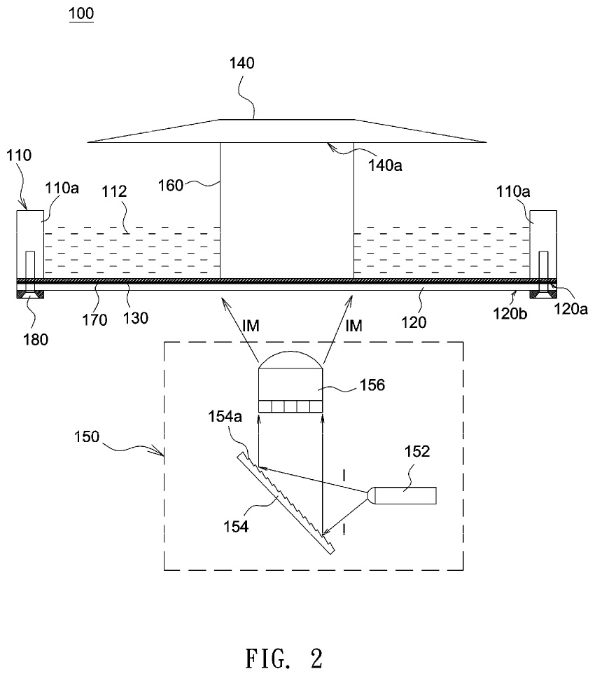

FIG. 2 is a schematic structural diagram of a three-dimensional (3D) printing device according to an embodiment of the invention. Referring to FIG. 2, in this embodiment, the 3D printing device 100 includes a material tank 110, a rigid optically transparent plate 120, a release film 130, a curing platform 140 and an imaging unit 150. The material tank 110 is provided with a space for accommodating a photo-curable material 112. The photo-curable material may be in a fluid state, gel formation or powder formation, and the photo-curable material may be a photopolymer, light-activated resin or photosensitive resin that can be cured by ultraviolet radiation. In this embodiment, the photo-curable material 112 is in a liquid state. The rigid optically transparent plate 120 is disposed at the bottom of the material tank 110 and has opposite first surface 120a and second surface 120b, and the release film 130 is disposed on side of the optically transparent plate 120 adjacent to the first surface 120a. In this embodiment, the rigid optically transparent plate 120 is a non-elastic member that does not produce substantial deformation when being bent.

The imaging unit 150 may be used to project an image beam IM. In this embodiment, the imaging unit 150 is a digital light processing (DLP) projector and may include a light source 152, a micro-mirror assembly 154 and a projection lens 156 disposed on one side of the rigid optically transparent plate 120 adjacent to the second surface 120b. The light source 152 is, for example, a light emitting diode (LED), a laser diode (LD) or other suitable light emitting elements, where a wavelength range of light emission of the light emitting element is selected according to the type of the photo-curable material 112. In this embodiment, the light source 152 emits an ultraviolet beam I, and the imaging unit 150 is an ultraviolet DLP projector, but the invention is not limited thereto. The micro-mirror assembly 154 is disposed at a position capable of forming a light path from the light source 152 to the rigid optically transparent plate 120, the rigid optically transparent plate 120 is disposed in a downstream light path of the projection lens 156, and the release film 130 is disposed in a downstream light path of the rigid optically transparent plate 120. Because light is transmitted from an upstream part to a downstream part of a light path, the phrase “a downstream light path of an optical component” can be understood as a light path that light propagates after passing through that optical component. For example, a propagation path of a light beam emitted by a light source 152 is considered as “a downstream light path of the light source”. In this embodiment, the light source 152 emits a light beam I to be transmitted to the micro-mirror assembly 154. When the light beam I irradiates a plurality of micro mirrors 154a of the micro-mirror assembly 154, the micro mirrors in “ON” state deflect and thus modulate part of the light beam I to the projection lens 156 to form an image beam IM. The image beam IM projected by the projection lens 156 passes through the rigid optically transparent plate 120 to irradiate the photo-curable material 112, so that the photo-curable material 112 is cured on a working surface 140a of the curing platform 140. After the photo-curable material 112 is solidified to form a hardened section 160, the curing platform 140 moves upwards to induce release actions. Specifically, when an adhesive force applied between the curing platform 160 and a hardened section 140 is greater than an adhesive force applied between the a release film 130 and the hardened section 24, the hardened section 160 is separated from the release film 130, and then the photo-curable material 112 may refill the space where the removed hardened section 160 formerly occupied. Then, the curing platform 140 moves downwards to squeeze the photo-curable material 112, and a subsequent solidification step is performed after extra amount of photo-curable material 112 is pushed away. Repetition of the above solidification step may complete a printing process and finally forms a multi-layer 3D object. In one embodiment, the time for refilling and pushing away the photo-curable material 112 may account for about 12.5% of the entire solidification time. In this embodiment, an adhesive layer 170 is disposed between the rigid optically transparent plate 120 and the release film 130 to adhere the release film 130 on the rigid optically transparent plate 120. Because the release film 130 is fixed on the rigid optically transparent plate 120 during printing, the release film 130 will not be repeatedly pulled to thus avoid deformation. Therefore, the service life of the release film 130 can be increased, and the advanced distance of the curing platform 140 and the overall printing time can be shortened to improve printing efficiency of the 3D printing device 100.

Further, in this embodiment, the material tank 110 is provided with a side wall 110a around the accommodating space, and the rigid optically transparent plate 120, the release film 130 and the adhesive layer 170 may be attached to the side wall 110a by a fastener 180, but the invention is not limited thereto. In other embodiment, only the rigid optically transparent plate 120 and the release film 130 are attached to the side wall 110a. In other embodiment, the rigid optically transparent plate 120, the release film 130 and the adhesive layer 170 may be attached to other part of the material tank 110 except for the side wall 110a. The overall rigidity can be enhanced by using the fastener 180, and the size as well as the manufacturing cost of the rigid optically transparent plate 120 can be further reduced by selecting a proper fastening position. Besides, use of the adhesive layer 170 may enhance the fixing strength to ensure that the release film 130 would not be pulled during the printing process.

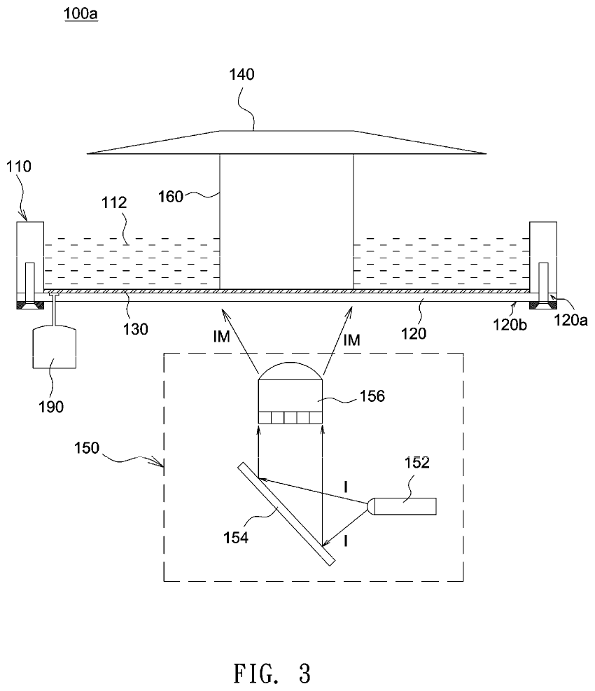

FIG. 3 is a schematic structural diagram of a three-dimensional printing device according to another embodiment of the invention. As shown in FIG. 3, in this embodiment, a vacuum pump 190 can be used to evacuate the space between the release film 130 and a rigid member (such as the rigid optically transparent plate 120) to fix the release film 130 on the rigid member (such as the rigid optically transparent plate 120) by vacuum adsorption during the printing process. This allows to omit the adhesive layer 170 from the printing device 100a but still achieves the effect of increasing the service life of the release film 130 and improving the printing efficiency. Moreover, in one embodiment, more than one securing means can be used at a time to further ensure that the release film 130 is firmly fixed on a rigid member. For example, the release film 130 can be both vacuum-adsorbed and glued to the rigid optically transparent plate 120.

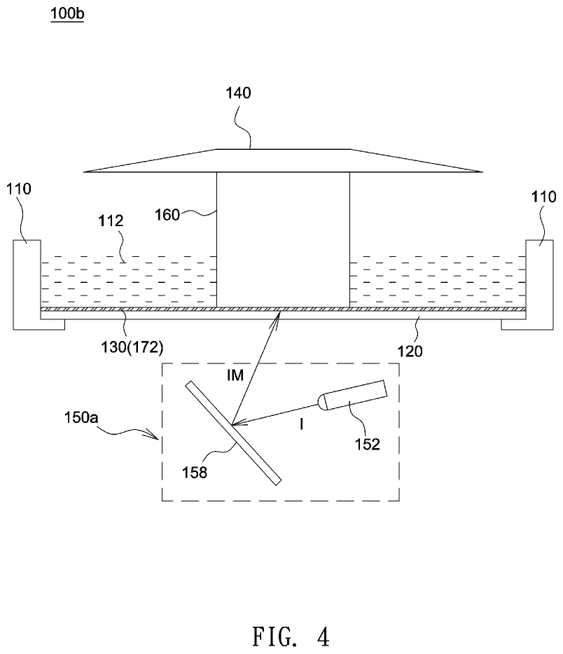

FIG. 4 is a schematic structural diagram of a three-dimensional printing device according to another embodiment of the invention. As shown in FIG. 4, an imaging unit 150a of a three-dimensional printing device 100a has at least one scanning mirror 158 that can move rapidly in two axes. The light source 152 may emit laser light, and the scanning mirror 158 may move rapidly to deflect the laser light to different positions to form an image composed of multiple light spots. Further, in this embodiment, a coating layer 172 can be directly coated on a rigid member (such as the rigid optically transparent plate 120) to serve as the release film 130, so the release film 130 is firmly fixed on the rigid member during the printing process to similarly achieve the effects of increasing the service life of the release film 130 and improving the printing efficiency. In addition, as shown in FIG. 4, the rigid optically transparent plate 120 may be supported and fixed on the bottom of the material tank 110 without using a fastener 180.

In various embodiments of the invention, the rigid optically transparent plate 120 may be an independent optically transparent plate disposed inside or outside the material tank 110, or may be a part of the material tank 110. For example, the optically transparent plate 120 may be made of a glass material with high ultraviolet transmittance. However, the optically transparent plate 120 is not limited to be made of glass, and it can be made of optically transparent polymer materials, such as resin or plastic. Further, in one embodiment, the rigid optically transparent plate 120 may be integrated formed as one piece using a single material, and no electronic component is provided inside or on a surface of the rigid optically transparent plate 120, so as to avoid heat generation and ease the process of fixing the release film 130 on the rigid optically transparent plate 120; for example, the arrangement of the adhesive layer 170 or the coating layer 172 on the optically transparent plate 120 would not be interfered by electronic components.

According to the above embodiments, a reflection assembly (such as the micro-mirror assembly 154 or the scanning mirror 158) of the imaging unit 150 and the light source 152 are disposed far away from the adhesive layer 170 or the coating layer 172, and a rigid member to which the adhesive layer 170 or the coating layer 172 is attached is an optically transparent plate without electronic components. This may avoid heat generation and reduce the possibility of softening a newly formed hardened section 160 and the possibility of deteriorating or damaging the adhesive layer 170 and the coating layer 172 due to heat. In the above embodiments, a distance between the light source 152 and the rigid optically transparent plate 120 may be greater than 5 cm and less than 50 cm; for example, the distance may be 10 cm. Besides, the light source 152 may be oriented in a direction not perpendicular to the rigid optically transparent plate 120.

In one embodiment, the adhesive layer 170 may be made of silicone, and the release film 130 may be made of polytetrafluoroethylene. In one embodiment, a thickness of the release film 130 is within a range of 0.05-0.35 mm, and preferably 0.1-0.35 mm, to strike a balance between reducing loss of optical power and providing sufficient structural strength. In this embodiment, a thickness of the release film 130 is 0.1 mm. In one embodiment, a thickness of the adhesive layer 170 is within a range of 0.03-0.1 mm, and preferably 0.03-0.05 mm, to strike a balance between reducing loss of optical power and providing sufficient structural strength. In this embodiment, a thickness of the adhesive layer 170 is 0.05 mm. In one embodiment, a thickness of the rigid optically transparent plate 120 is within a range of 1-3 mm. In one embodiment, a printing area of the curing platform 140 is generally rectangular and is about half of the bottom area of the material tank 110. Besides, a distribution area of the adhesive layer 170 is 100%-300% of the printing area of the three-dimensional printing device, and preferably more than 150%. Because a larger area of the adhesive layer 170 allows for stricter adherence but also increases fabrication costs, the above range can strike a balance between providing sufficient adhesive force and reducing fabrication costs. In this embodiment, the distribution area of the adhesive layer 170 is 150% of the printing area of the three-dimensional printing device. Moreover, in one embodiment, the distribution area of the adhesive layer 170 may account for 50%-100% of the area of a first surface 120a of the rigid optically transparent plate 120.

Based on the above, the three-dimensional printing device of the invention has at least one of the following advantages. According to various embodiments of the invention, because the release film is fixed on a rigid member during the printing process, the release layer would not be pulled repeatedly to avoid deformation, so the service life of the release film can be increased, and an advanced distance of the curing platform and printing time can be shortened to improve the printing efficiency of a three-dimensional printing device. Further, with the designs of the above embodiments, the reflection assembly and the light source of the imaging unit are disposed far away from the adhesive layer or the coating layer, and the rigid member to which the adhesive layer or the coating layer is attached is an optically transparent plate without any electronic component to avoid heat generation. This may prevent heat from transmitting to the adhesive layer, the coating layer or the newly formed hardened section and hence reduce the possibility of softening, deteriorating or damaging the adhesive layer, the coating layer or the hardened section.

Though the embodiments of the invention have been presented for purposes of illustration and description, they are not intended to be exhaustive or to limit the invention. Accordingly, many modifications and variations without departing from the spirit of the invention or essential characteristics thereof will be apparent to practitioners skilled in this art. It is intended that the scope of the invention be defined by the claims appended hereto and their equivalents in which all terms are meant in their broadest reasonable sense unless otherwise indicated.

What is claimed is:

1. A three-dimensional printing device, comprising:
a rigid optically transparent plate having a first surface and a second surface opposite the first surface;
a release film disposed on a side of the rigid optically transparent plate adjacent to the first surface;
an adhesive layer arranged between the rigid optically transparent plate and the release film;
a light source disposed on a side of the rigid optically transparent plate adjacent to the second surface; and
a reflection assembly comprising at least one mirror and arranged at a position capable of forming a light path from the light source to the rigid optically transparent plate.

2. The three-dimensional printing device as claimed in claim 1, wherein the reflection assembly is a micro-mirror assembly or a scanning mirror.

3. The three-dimensional printing device as claimed in claim 1, further comprising a projection lens arranged on the side of the rigid optically transparent plate adjacent to the second surface and in a downstream light path of the light source.

4. The three-dimensional printing device as claimed in claim 1, further comprising a material tank for accommodating a photo-curable material, wherein the rigid optically transparent plate and the release film are fixed on the material tank.

5. The three-dimensional printing device as claimed in claim 1, wherein a thickness of the release film ranges from 0.1 mm to 0.15 mm, a thickness of the adhesive layer ranges from 0.03 mm to 0.05 mm, and a thickness of the rigid optically transparent plate ranges from 1 mm to 3 mm.

6. The three-dimensional printing device as claimed in claim 1, wherein a distribution area of the adhesive layer is more than 150% of a printing area of the three-dimensional printing device.

7. The three-dimensional printing device as claimed in claim 1, wherein a distance between the light source and the rigid optically transparent plate is greater than 5 cm.

8. The three-dimensional printing device as claimed in claim 1, wherein an orientation of the light source is not perpendicular to the rigid optically transparent plate.

9. The three-dimensional printing device as claimed in claim 1, wherein the rigid optically transparent plate is made of a single material, and no electronic component is provided inside or on the rigid optically transparent plate.

10. The three-dimensional printing device as claimed in claim 1, wherein the adhesive layer is made of silicone, the release film is made of polytetrafluoroethylene, and the light source is an ultraviolet light source.

11. A three-dimensional printing device, comprising:
a light source capable of emitting a light beam;
a micro-mirror assembly arranged in a downstream light path of the light source;
a projection lens arranged in a downstream light path of the micro-mirror assembly;
a material tank provided with a space for accommodating a photo-curable material;
a rigid optically transparent plate disposed at a bottom of the material tank and in a downstream light path of the projection lens, wherein the rigid optically transparent plate has a first surface and a second surface opposite the first surface; and
a release film disposed in a downstream light path of the rigid optically transparent plate, wherein the release film is configured to be fixed on the rigid optically transparent plate during a printing process of the three-dimensional printing device.

12. The three-dimensional printing device as claimed in claim 11, wherein the release film is adhered, fastened or vacuum-adsorbed on the rigid optically transparent plate.

13. The three-dimensional printing device as claimed in claim 11, wherein the release film is a coating layer formed on the rigid optically transparent plate.

14. The three-dimensional printing device as claimed in claim 11, wherein a distance between the light source and the rigid optically transparent plate is greater than 5 cm.

15. The three-dimensional printing device as claimed in claim 11, wherein an orientation of the light source is not perpendicular to the rigid optically transparent plate.

16. The three-dimensional printing device as claimed in claim 11, wherein the rigid optically transparent plate is made of a single material, and no electronic component is provided inside or on the rigid optically transparent plate.

17. The three-dimensional printing device as claimed in claim 11, wherein the adhesive layer is made of silicone, and the release film is made of polytetrafluoroethylene.

18. The three-dimensional printing device as claimed in claim 11, wherein the light source is an ultraviolet light source.

19. The three-dimensional printing device as claimed in claim 11, wherein a thickness of the release film ranges from 0.1 mm to 0.15 mm, a thickness of the adhesive layer ranges from 0.03 mm to 0.05 mm, and a thickness of the rigid optically transparent plate ranges from 1 mm to 3 mm.

20. The three-dimensional printing device as claimed in claim 11, wherein a distribution area of the adhesive layer is more than 150% of a printing area of the three-dimensional printing device.
